(19) United States
(12) Patent Application Publication
(10) Pub. No.: US 2008/0279434 A1
(43) Pub. Date: Nov. 13, 2008

(54) Method and system for automated modeling

(76) Inventor: William Cassill, Issaquah, WA (US)

Correspondence Address: OLYMPIC PATENT WORKS PLLC, P.O. BOX 4277, SEATTLE, WA, 98104, US

(21) Appl. No.: 11/803,156

(22) Filed: May 11, 2007

(51) Int. Cl. G06K 9/00

(52) U.S. Cl. 382/131

(57) ABSTRACT

Embodiments of the present invention include automated methods and systems for statistical modeling in high-dimensional problem domains. The automated statistical-analysis methods and systems of the present invention employ computationally efficient methods for preparing large amounts of high-dimensional data for analysis, computationally efficient methods for selecting and transforming predictors, and, based on these methods, computationally efficient model-building methods to generate effective prediction models. Embodiments of the present invention are especially useful when the high-dimensional nature of a problem domain exceeds that of problem domains that can be analyzed by human statisticians, or by human-guided automated systems, within reasonable time and budget constraints.

Two identical CDs identified as “Disk 1 of 2” and “Disk 2 of 2,” containing SAS program source code implementing an embodiment of the present invention, are included as a computer program listing appendix. The program text can be viewed on a personal computer running a Microsoft Windows operating system, using Microsoft Notepad or other utilities used for viewing ASCII files. Each disk contains the following directories and files:

automated_modeling_engine_SAS-script2.sas

### TECHNICAL FIELD

The present invention is related to statistical analysis and, in particular, to an automated system for building predictive models from extremely high-dimensional sample spaces.

### BACKGROUND OF THE INVENTION

Computer-aided statistical analysis is widely used in many different fields, from public health and medical research to marketing analysis and inventory management, and from the design and interpretation of scientific experiments to Internet-based data mining and directed searching. While traditional mathematical fields, including a number of fields related to probability and statistics, were well developed and mature prior to the advent of inexpensive, high-speed computing resources, statistical analysis has continued to relentlessly advance, with many advances particularly directed to methods for computational statistical modeling. While many of the already well-developed statistical methods and new advances provide very useful methods in particular problem domains, they may need careful evaluation and human-guided application when applied to new, or generalized problem domains. Furthermore, when the dimensionality of a problem domain is greater than fairly modest dimensionalities, of between 40 and 50 independent variables, many statistical methods become computationally unfeasible, or generate models with unacceptably low prediction power. Unfortunately, in many applications in high-dimensional problem domains, there are insufficient financial resources and time for undertaking the careful, human-guided application of many modern statistical methods and automated statistical-analysis systems. For this reason, many statisticians, and a large number of manufacturers, service providers, and researchers have recognized the need for computationally efficient, time-efficient, automated modeling methods and systems to allow effective models to be rapidly constructed and applied in high-dimensional problem domains.

### SUMMARY OF THE INVENTION

Embodiments of the present invention include automated methods and systems for statistical modeling in high-dimensional problem domains. The automated statistical-analysis methods and systems of the present invention employ computationally efficient methods for preparing large amounts of high-dimensional data for analysis, computationally efficient methods for selecting and transforming predictors, and, based on these methods, computationally efficient model-building methods to generate effective prediction models. Embodiments of the present invention are especially useful when the high-dimensional nature of a problem domain exceeds that of problem domains that can be analyzed by human statisticians, or by human-guided automated systems, within reasonable time and budget constraints.

### BRIEF DESCRIPTION OF THE DRAWINGS

FIG. 1 illustrates an example problem domain to which embodiments of the present invention may be applied.

FIG. 2 abstractly illustrates a problem addressed by methods of the present invention, and illustrates certain descriptive conventions used in the following discussion.

FIG. 3 illustrates just a few of the possible different types of data types that may be present in a data set.

FIG. 4 shows a simple logical dependency graph for a relatively small number of independent variables.

FIG. 5 is a control-flow diagram illustrating one embodiment of the present invention.

FIGS. 6-7 illustrate small portions of an exemplary data file and accompanying data dictionary, received in step 502 of the method embodiment of the present invention illustrated in FIG. 5.

FIG. 8 illustrates transformation of a categorical variable into a corresponding numerical variable according to one embodiment of the present invention.

FIG. 9 illustrates replacement of missing data values and removal of extreme data values for continuous independent variables, carried out in step 504 of FIG. 5, according to one embodiment of the present invention.

FIG. 10 is a control-flow diagram illustrating one embodiment of step 506 in FIG. 5 according to one embodiment of the present invention.

FIG. 11 shows a control-flow diagram for forward stepwise regression according to one embodiment of the present invention.

FIG. 12 shows a control-flow diagram for the routine “addCandidate,” called in step 1109 of FIG. 11, according to one embodiment of the present invention.

FIG. 13 is a control-flow diagram for the routine “removePredictors,” called in step 1113 of FIG. 11, according to one embodiment of the present invention.

FIG. 14 illustrates the routine “backwardselimination” according to one embodiment of the present invention.

FIG. 15 is a control-flow diagram for the routine “forwardRegression” according to one embodiment of the present invention.

FIGS. 16A-E illustrate linear spline transformation of a non-linear function.

FIG. 17 is a control-flow diagram for the routine “findPredictorTransformations,” called in step 508 of FIG. 5, according to one embodiment of the present invention.

FIG. 18 is a control-flow diagram for a first embodiment of the routine “buildModel” called in step 510 of FIG. 5, according to one embodiment of the present invention.

FIG. 19 illustrates an alternative “buildModel” routine according to one embodiment of the present invention.

FIG. 20 is a control-flow diagram that illustrates the second “buildModel” routine called in step 510 of FIG. 5 in an alternate embodiment of the present invention.

FIG. 21 illustrates model validation in one embodiment of the present invention.

### DETAILED DESCRIPTION OF THE INVENTION

Method and system embodiments of the present invention are directed to automated statistical modeling. In a first subsection, below, the general problem domain addressed by method and system embodiments of the present invention is described. In a next subsection, an overview of certain statistical methods and metrics is provided. In a third subsection, problems with currently available analysis techniques are described. Finally, in a fourth subsection, method and system embodiments of the present invention are described, in detail, with reference to control-flow diagrams. A full Statistical-Analysis-Software (“SAS”) program for one embodiment of the present invention is included in Appendix A.

### Problem Domain

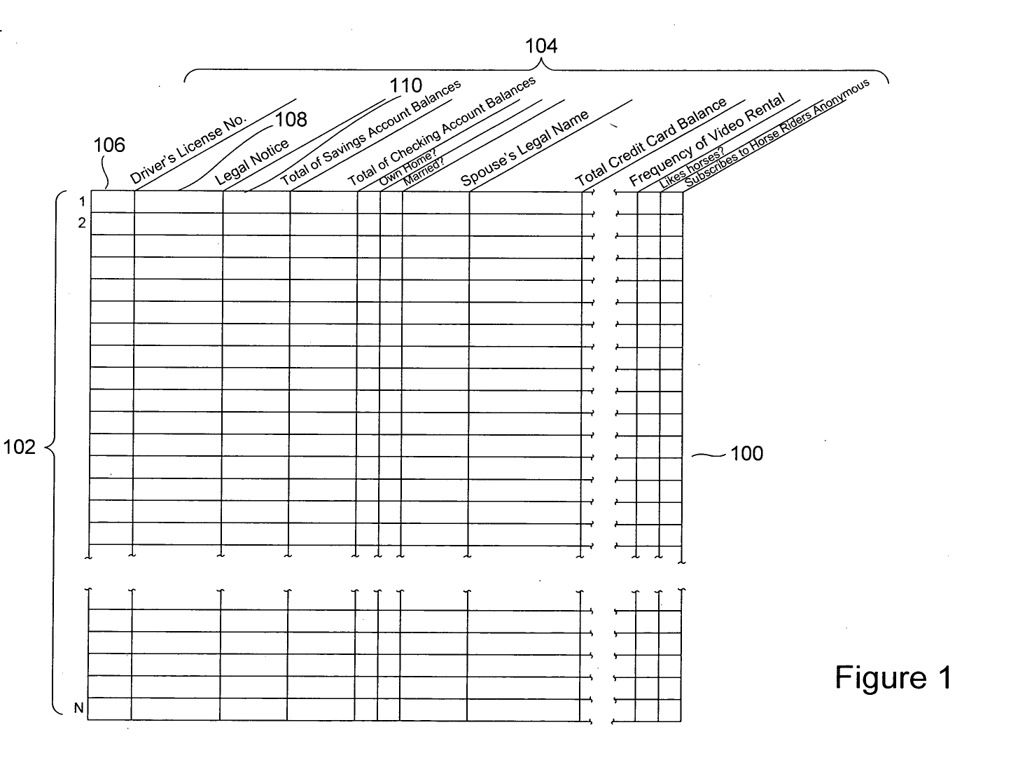

FIG. 1 illustrates an example problem domain to which embodiments of the present invention may be applied. FIG. 1 shows a data set 100 in tabular form. The data set comprises a larger number of records 102, or rows, 1, 2, . . . , N, each row, or record, including a large number of values corresponding to fields 104, or columns, of the data set. In the example shown in FIG. 1, each record may represent a person, and each column represents a type of information known about each person described by the data set. Columns in FIG. 1 include driver's license number 106, legal name 108, savings account balances 110, and many other such fields. Initially, a driver's license number may appear to be of little predictive power for many other types of fields, since a driver's license number may be arbitrarily defined. However, in other cases, a driver's license number may itself comprise a number of numeric and alphanumeric fields, certain of which may encode information related to geographic location, name, age, and other such characteristics. In certain systems, fields with arbitrary values and therefore without predictive power may not be included in data sets. In other cases, fields with potential correlations, such as certain sub-fields within a driver's license number, may be transformed to heighten and make clear such correlations, such as, for example, transforming a street address into a longitude/latitude pair. In still other cases, the predictive power of fields may be determined through the field-selection techniques described below, with fields lacking predictive power removed from consideration as the number of fields included in a final model is winnowed down to a subset with strong predictive power. Embodiments of the present invention are particularly useful when the data set 100 has high dimensionality or, in other words, has a large number of columns, or fields. In addition, embodiments of the present invention are particularly useful when the high-dimensional data sets also include a large number of records, or rows. For example, typical data sets to which methods of the present invention are applied may contain many hundreds or thousands of columns and many thousands, tens of thousands, hundreds of thousands, millions, or more rows.

The data types of the values in the records may include integers, real numbers, and floating point numbers that expressed in various binary encodings, logic values, character strings, and categorical values, such as a set of character strings representing a set of discrete, possible values for a particular field the records. In many cases, the information within the data set may be incomplete and/or inconsistent. For example, many fields within a record may be empty, indicating no information for that field, and the values in a record for logically interrelated fields may be inconsistent with the logical relationships among the fields. For example, a field may indicate the number of credit cards currently employed by an individual, while other fields indicate specific credit-card identifiers. In certain circumstances, the number-of-credit-cards field may contain a numerical entry less than the total number of credit-card identifiers within credit-card-identifier fields.

The general problem associated with data sets, such as the data set shown in FIG. 1, is that a model needs to be built, based on a training data set, to predict values of one or more dependent fields, or columns, of similar, subsequently provided records. For example, in a marketing analysis, a data set may include a dependent column, or field, indicating the likelihood that each described person will purchase a new car during the next month. A model is built, using a training data set, to predict this likelihood based on the remaining fields of the training data set. Subsequently, the model can be applied to information provided for potential consumers to predict which of those consumers are most likely to purchase an automobile within the next 30 days. Such information can be used to target costly marketing resources to the most promising of potential customers.

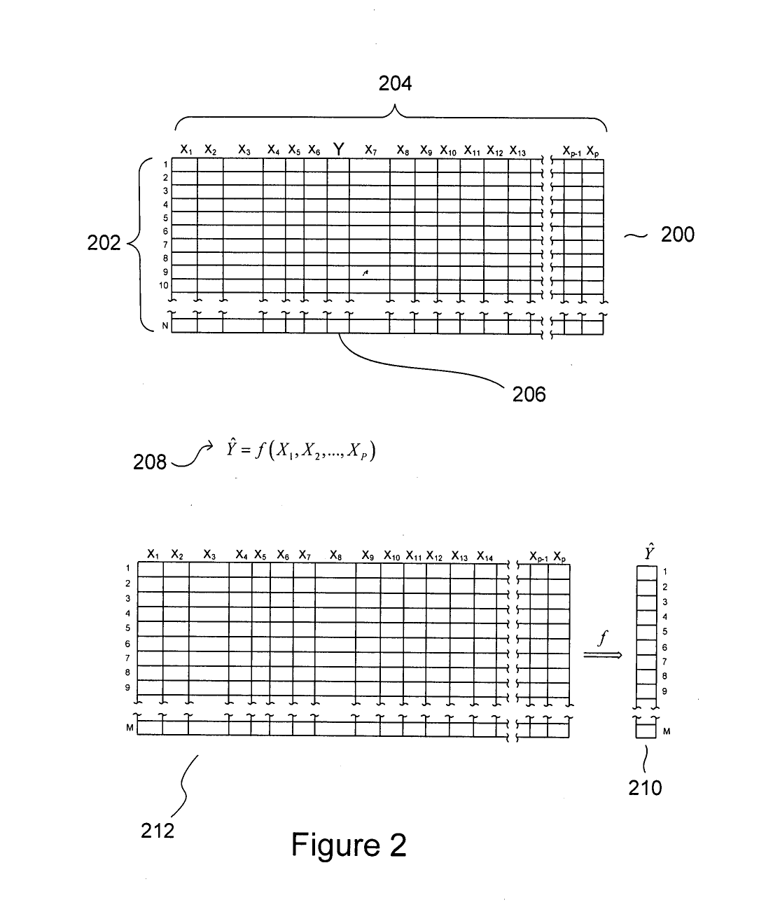

FIG. 2 abstractly illustrates a problem addressed by methods of the present invention, and illustrates certain descriptive conventions used in the following discussion. A sample data set 200 is used to build a predictive model. The sample data set contains N samples, or rows, 202 and P+1 columns 204. One column (206 in FIG. 2) is identified as the dependent variable for the problem, Y. The remaining P columns comprise the independent variables X₁, X₂, X₃, . . . X_{P}. An automated model-building technique that represents an embodiment of the present invention is applied to the sample data set 200 to generate a predictive model 208. The predictive model can be thought of as a function

Ŷ=ƒ(X₁, X₂, . . . , X_{P})

In other words, the predictive model is a function of the independent variables that returns a predicted value Ŷ for the dependent variable Y. The function can be applied to a record to produce a predicted value for the field of the record corresponding to the dependent variable Y. As discussed below, in general, a useful and computationally feasible predictive function is a function of Q independent variables, where Q is less than P:

Ŷ=ƒ(X₁, X₂, . . . , X_{Q})

where Q<P. However, rather than making this distinction between the total number of potential independent variables and actual independent variables used, the number of independent variables used in a model will be referred to as the predictors {X₁, X₂ . . . X_{P}, where the number of predictors P is less than or equal to the number of independent variables in the sample data set. The generated predictive model 208 then allows for predicting a vector of values Ŷ 210 based on a subsequently provided data set 212 by applying the predictive model 208 to each row, or record, in the subsequently provided data set 212.

### Overview of Statistical Methods and Metrics

One traditional method for addressing prediction problems, such as the problem discussed with reference to FIG. 2, is referred to as “linear regression.” Linear regression is briefly summarized, below. More detailed discussions of linear regression can be found in any number of different textbooks and online encyclopedias. In linear-regression analysis, the predictor function is assumed to be linear:

$$f ( {X}_{1} , {X}_{2} , … , {X}_{P} ) = {β}_{0} + {\sum }_{j = 1}^{P} {X}_{j} {β}_{j}$$

where β₀ is an intercept, and the coefficients β₁, β₂, . . . β_{P} are multiplicative coefficients of the predictor variables X₁, X₂, . . . , X_{P}. It is customary to incorporate the intercept coefficient β₀ into a matrix-and-vector-based formalism. A constant predictor variable X₀ is assumed, with constant value 1, so that the predictor variables can be expressed as a column vector X:

$${X}_{0} = 1$$

$${X}^{T} = [ {X}_{0} , {X}_{1} , {X}_{2} , … , {X}_{P} ]$$

$$β = [ \begin{matrix}{β}_{0} \\ {β}_{1} \\ ⋮ \\ {β}_{P}\end{matrix} ]$$

This allows the predictor function to be expressed, in vector notation, as:

$$f ( X ) = {\sum }_{j = 0}^{P} {X}_{j}^{T} {β}_{j}$$

One measure of the quality, or usefulness, of the predictor function is the residual sum of squares (“RSS”), given by:

$$RSS = {\sum }_{i = 1}^{N} {( {Y}_{i} - f ( {X}_{i} ) )}^{2}$$

where Yᵢ is the dependent-variable value for sample i and ƒ(Xᵢ) is the predicted dependent variable for sample i. Note that, in the current discussion, there is only a single dependent variable. However, the linear-regression technique is easily and straightforwardly applied to k multiple dependent variables, where k is the number of dependent variables, and a matrix of coefficients of dimensionality P×k is used, rather than vector. However, for ease of description, single-dependent-variable methods are discussed in the current and several following paragraphs as well as in later-described embodiments of the present invention. The RSS can be thought of as a function of the coefficients β₁, β₂, . . . , β_{P}, and can be expressed in matrix notation as:

$$RSS ( β ) = {( Y - X β )}^{T} ( Y - X β )$$

$$where$$

$${β}^{T} = [ {β}_{0} , {β}_{1} , … , {β}_{P} ] , \\ {Y}^{T} = [ {Y}_{0} , {Y}_{1} , … , {Y}_{N} ] , and$$

$$X = [ \begin{matrix}1 , & {X}_{1 , 1} , & {X}_{1 , 2} , & … , & {X}_{1 , P} \\ 1 , & {X}_{2 , 1} , & {X}_{2 , 2} , & … , & {X}_{2 , P} \\ ⋮ & ⋮ & ⋮ & & ⋮ \\ 1 , & {X}_{N , 1} , & {X}_{N , 2} , & … , & {X}_{N , P}\end{matrix} ]$$

In order to determine a set of coefficients β, the partial differential of RSS with respect to the β coefficients is set to 0, in order to find the minimal RSS, and the β coefficients are then solved for, in a system of linear equations in which the first partial derivatives of RSS with respect to the β coefficients are all 0, as follows:

$$\frac{\partial RSS}{\partial β} = 2 {X}^{T} ( Y - X β )$$

$$\frac{{\partial }^{2} RSS}{\partial β \partial {β}^{T}} = - 2 {X}^{T} X$$

$$\frac{\partial RSS}{\partial β} = 0 = ( Y - X β )$$

$$\hat{β} = {( {X}^{T} X )}^{- 1} {X}^{T} Y$$

where \hat{β} represents the β coefficients determined by the above, least-squares method. Thus, the determined predictor function \hat{ƒ}(X) is expressed as:

$$\hat{f} ( X ) = {\sum }_{j = 0}^{P} {X}_{j} {\hat{β}}_{j}$$

The variance of the coefficients \hat{β} is expressed as a square matrix, referred to as the covariance matrix, as follows:

Var(\hat{β})=(X^{T}X)^{'1} ρ²

where the constant variance σ²is estimated as:

$${\hat{σ}}^{2} = \frac{1}{N - P - 1} {\sum }_{i = 1}^{N} {( {Y}_{i} - {\hat{Y}}_{i} )}^{2}$$

The standard error for a particular coefficient βᵢ is:

σ(\hat{β}ᵢ)=\sqrt{Var(\hat{β})ᵢᵢ}

where Var(\hat{β})ᵢᵢ is the diagonal element of the covariance matrix with indices [i,i]. Finally, the significance level of a particular coefficient \hat{β}ᵢ is obtained using a t-statistic:

$$t = \frac{{\hat{β}}_{i}}{σ ( {\hat{β}}_{i} )}$$

in a t-test to test whether the parameter \hat{β}ᵢ is different from 0. Generally, a significance level is employed to generate a p value for each \hat{β}ᵢ parameter, with small p values indicative of a high probability that the parameter \hat{β}ᵢ is not 0, or is, in other words, significant with respect to the dependent variable.

The F test may be used to assess the significance of a model parameter. Once a model has been built, parameters can be tested individually, or in groups, based upon their contribution to the R square or RSS statistics. For a single parameter test, the formula is:

$${F}_{i} = \frac{RSS ( all ) - RSS ( all - {\hat{β}}_{i} )}{RSS ( all ) / ( n - {k}_{all} - 1 )}$$

$$or$$

$${F}_{i} = \frac{( {R}_{all}^{2} - {R}_{( all - {\hat{β}}_{i} )}^{2} )}{( 1 - {R}_{all}^{2} ) / ( n - {k}_{all} - 1 )}$$

where Fᵢ is the F statistic associated with parameter \hat{β}ᵢ, N is the number of rows in the data file, and kₐₗₗ is the number of model parameters minus the intercept, and all stands for all model parameters other than \hat{β}. An alternative version concerns when a new term is added to the current model. In this case the formulation becomes:

$${F}_{i} = \frac{RSS ( {alt}_{i} ) - RSS ( curr )}{RSS ( {alt}_{i} ) / ( n - {k}_{{alt}_{i}} - 2 )}$$

$$or \text{:}$$

$${F}_{i} = \frac{( {R}_{{alt}_{i}}^{2} - {R}_{curr}^{2} )}{( 1 - {R}_{{alt}_{i}}^{2} ) / ( n - {k}_{{alt}_{i}} - 2 )}$$

where altᵢ=current parameters+\hat{β}ᵢ

The R² statistic may be used, like the RSS statistic, to judge the fidelity of the predictive model:

$${R}^{2} = 1 - \frac{{\sum }_{i = 1}^{N} {( {y}_{i} - {\hat{y}}_{i} )}^{2 }}{{\sum }_{i = 1}^{N} {( {y}_{i} - \overline{y} )}^{2}}$$

where ŷᵢ=ƒ(xⱼ)

The above linear-regression technique assumes a continuous-valued dependent variable. For non-numeric dependent variable, such as true-and-false valued dependent variables, or dependent variables with a small number of discrete, categorical values, a maximum-likelihood-based regression is commonly employed. One maximum-likelihood-based regression for a two-valued dependent variable is referred to as binary logistic regression. Binary logistic regression is designed to model binary outcome variables, typically where “1” indicates “success” and “0” or “2” indicates “failure.” The linkage function for the logistic regression model is:

$$\frac{1}{1 + {exp}^{- \hat{z}}}$$

where \hat{z} is a linear function of one or more input variables and an intercept:

\hat{z}=\hat{β}₀+\hat{β}₁x₁+ . . . +\hat{β}ₖxₖ \hat{β}=\hat{β}₀, . . . , \hat{β}ₖ

Maximum likelihood estimation is the typical method of optimizing the parameters of the logistic regression function. In the case of binary logistic regression model the likelihood function is:

$$L ( \hat{B} \vert Y ) = {\prod }_{i = 1}^{N} {{\hat{Π}}_{i}^{{Y}_{1}} ( 1 - {\hat{Π}}_{i} )}^{1 - {Y}_{i}}$$

where \hat{Π}ᵢ is the probability function, as expressed in the logistical regression model linkage function, and Yᵢ is the binary (0,1) dependent variable for sample i. However, the log-likelihood is often used for computational efficiency:

$$l ( \hat{B} ) = ln ( L ( \hat{B} \vert Y ) ) = {\sum }_{i = 1}^{N} {Y}_{i} ln ( {\hat{Π}}_{i} ) + ( 1 - {Y}_{i } ) ln ( 1 - {\hat{Π}}_{i} )$$

$$or$$

$$l ( \hat{B} ) = ln ( L ( \hat{B} \vert Y ) ) = {\sum }_{i = 1}^{N} {Y}_{i} {\hat{z}}_{i} - ln ( 1 + {e}^{{\hat{z}}_{i}} )$$

The gradient or score function for parameter Bₖ is given by:

$$\frac{\partial l ( \hat{B} )}{\partial {\hat{B}}_{k}} = {\sum }_{i = 1}^{N} {X}_{ik} ( {Y}_{i} - {\hat{Π}}_{i} )$$

Similarly, the second derivative of the log-likelihood function is defined as follows:

$$\frac{{\partial }^{2} l ( \hat{B} )}{\partial {\hat{B}}_{j} \partial {\hat{B}}_{k}} = - {\sum }_{i = 1}^{N} {X}_{ik} {X}_{ij} ( 1 - {\hat{Π}}_{i} ) {\hat{Π}}_{i}$$

A K×K matrix of second derivatives, or Hessian matrix, is used by the Newton-Raphson algorithm to iteratively update the parameters Θ until convergence is achieved. The Newton-Raphson algorithm updates the parameters according to the formula:

$${\hat{B}}_{t + 1} = {\hat{B}}_{t} - \frac{{\partial }^{2} {l ( {\hat{B}}_{t} )}^{- 1}}{\partial {\hat{B}}_{t} \partial {\hat{B}}_{t}^{′}} \frac{\partial l ( {\hat{B}}_{t} )}{\partial {\hat{B}}_{t}}$$

or, in matrix form:

\hat{B}ₜ₊₁=\hat{B}ₜ+(X^{T}WₜX)⁻¹ X^{T}(Y−\hat{Π})

where Bₜ are the likelihood estimates at time t, X is the N×P matrix of independent variables, including an intercept constant column with all values equal to “1”, and Wₜ is an N×N diagonal matrix with elements wⱼⱼ=(1−πⱼ)πⱼ. Y is an N×1 matrix of dependent variable values ε{0, 1}, and π is an N×1 matrix of probability estimates derived from the logistic linkage function.

The Newton-Raphson algorithm continues to iterate until convergence is achieved. Although a number of methods exist, a popular method is based upon the relative change in the log-likelihood:

$$\frac{\vert l ( {\hat{B}}_{t} ) - l ( {\hat{B}}_{t - 1} ) \vert}{l ( {\hat{B}}_{t - 1} ) + w} < eps$$

where w is an arbitrarily small number (e.g., 1 E-6) and eps is a convergence criterion (e.g., 1 E-8 or smaller).

To test whether one or more parameters are significantly different from 0, a Wald statistic may be used. The general formula for the Wald statistic is:

Wald=[Q\hat{B}]^{T} [QVar(\hat{B})Q^{T}][Q\hat{B}]

where \hat{B} is a P×1 matrix of model parameters, Q is a 1×P design matrix consisting of 1's and 0's, and Var(\hat{B}) is an information matrix equal to the negative inverse of the Hessian matrix of second derivatives:

$$Var ( \hat{B} ) = - \frac{{\partial }^{2} {l ( \hat{B} )}^{- 1}}{\partial \hat{B} \partial {\hat{B}}^{′}}$$

The Wald statistic can be used to test a single parameter or multiple parameters at the same time. Q has one row for each tested parameter. For testing a single parameter, Q would be a 1×P matrix, with a “1” corresponding to the parameter to be tested, and “0” values for everything else. The Wald statistic follows a χ² distribution with df equal to the number of rows in Q.

The binary logistic regression can be straightforwardly generalized to a k-wise categorical dependent variable, as discussed in numerous textbooks on statistics and in numerous online encyclopedias and online discussions.

Finally, one technique for quickly evaluating whether or not a particular independent variable of Xⱼ of a data set is correlated with the dependent variable Y is to compute the Pearson correlation for the independent variable as follows:

$$r = \frac{{\sum }_{i = 1}^{N} ( {y}_{i} - \overline{y} ) ( {x}_{i} - \overline{x} )}{\sqrt{{\sum }_{i = 1}^{N} {( {y}_{i } - \overline{y} )}^{2} \sqrt{{\sum }_{i = 1}^{N} {( {x}_{i} - \overline{x} )}^{2}}}}$$

where r=1.0 for perfect correlation, r=0.0 for no correlation, and r=−1.0 for perfect negative correlation.

### Problems With Currently Available Analysis Techniques

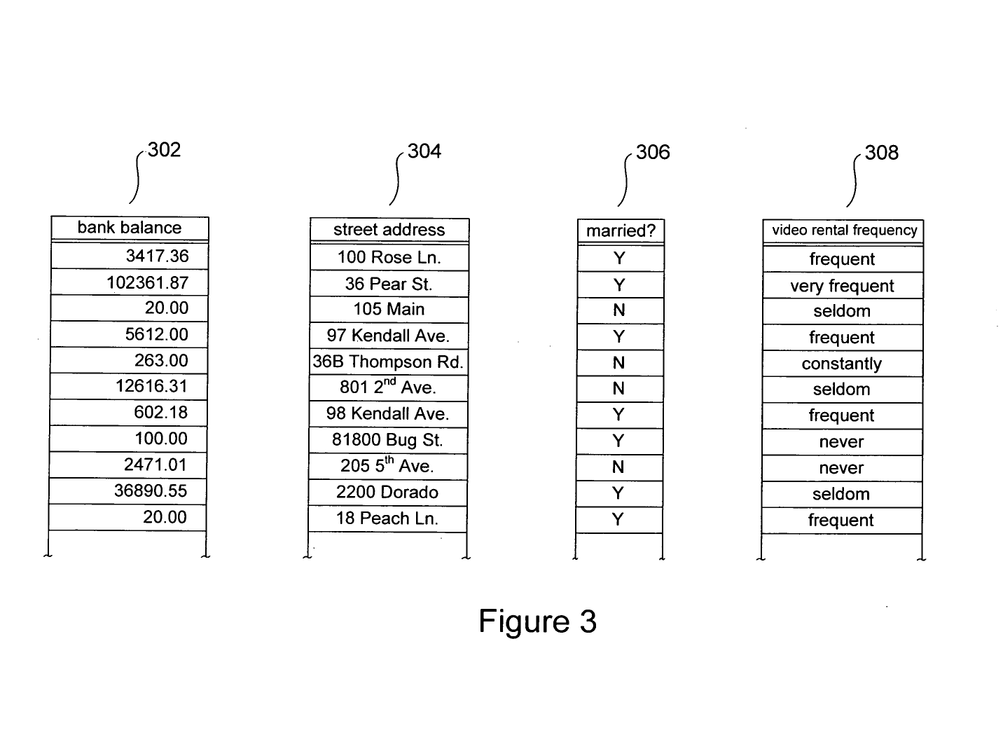

FIG. 3 shows some example columns from an example data set. The columns, or independent variables, include a bank balance column 302, a street-name column 304, a “married?” column 306, and a video-rental-frequency column 308. The bank-balance column 302 can be seen to contain continuous, numeric values. The street-name column 304 contains character strings. The “married?” column 306 contains “yes” and “no” values. The video-rental-frequency column 308 includes categorical values selected from the set {“never,” “seldom,” “frequent,” “very frequent,” “constantly”}. FIG. 3 illustrates just a few of the possible different types of data types that may be present in a data set. The bank-balance independent variable is definitely a continuous variable, the “married?” variable 306 is definitely a binary, discontinuous variable, the video-rental-frequency variable 308 is a categorical variable, and the street-name variable is a character string variable, each instance of the character string essentially representing a location identifier.

In many low-to-medium dimensionality problem domains, it is possible for a human statistician, or for an automated statistical package guided by a human analyst, to analyze a data set in order to account for incomplete and inconsistent data, to determine logical relationships between fields or columns within the data set, and to determine a subset of the columns, or fields, to use as predictors in a statistical model for predicting one or more dependent columns or fields. However, in the high-dimensionality data sets to which method and system embodiments of the present invention are applied, manual statistical analysis is generally infeasible. Data sets are typically too large for such analysis, and the problem of understanding interrelationships between columns, or fields, is intractable.

As discussed below, various different techniques are employed to prepare different types of data values for analysis in model building. Furthermore, the different data types are also related to the problem of determining the logical interdependence of independent variables, and the significance, or correlation, of independent variables with a dependent variable. For example, if the dependent variable, for the data set from which the columns shown in FIG. 3 are selected, is likelihood of purchasing a new car within the next 30 days, then it might logically be inferred that the bank-balance independent variable may be correlated with the dependent variable, while correlations with the other independent variables are much less certain. Perhaps street-name identifiers identifying streets within a wealthy neighborhood, versus street-name identifiers identifying streets in a poor neighborhood, may correlate with the likelihood of purchasing a new car, but the street-name values would probably need to be transformed to neighborhood identifiers in order for a strong correlation to emerge. The video-rental-frequency variable is probably not correlated with the likelihood of purchasing a new car. However, deciding whether or not logical correlations or dependencies exist between independent variables and between independent variables and a dependent variable is, in many cases, very difficult, and assumed logical correlations may not, in fact, be reflected in the data set. For example, although one might infer that a large bank balance should correlate with likelihood of purchasing a new car, it may turn out that the majority of assets in a community or region are not stored in bank accounts, but in other assets, and only miserly individuals in the community or region have large bank accounts. In this case, a large bank balance may contrary to initial expectations, negatively correlate with likelihood of purchasing a new car.

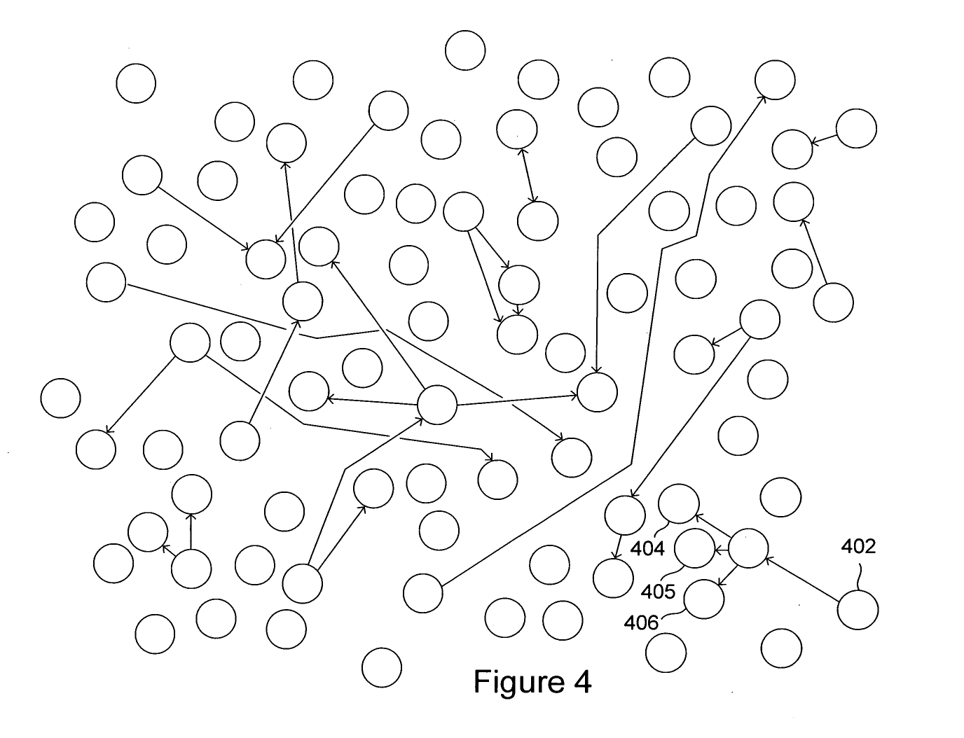

As can easily be imagined, when the number of potential predictive variables in a data set runs to many hundreds or thousands, the problem of determining logical dependencies becomes quite intractable. FIG. 4 shows a simple logical dependency graph for a relatively small number of independent variables. The independent variables are shown, in FIG. 4, as circles. Logical dependencies are represented by directed line segments, or arrows. Logical variables without incoming or outgoing arrows are essentially not correlated with other independent variables. Logical dependencies may form linear or branching paths through the independent-variable space, such as the branching path from independent variable 402 to independent variables 404-406. Even in this relatively small problem space, it would require a massive effort for a human statistician to attempt to determine whether any particular independent variable is correlated with another independent variable or with a dependent variable lacking explicit indications of the dependency relation.

Furthermore, naive approaches to predictor selection involving linear-regression-based techniques may involve attempts to invert enormous matrices. The computational complexity of matrix inversion is greater than O(n²), so that the time to carry out matrix-inversion grows quickly with increasing training-data-set sizes. For this reason, alone, naïve approaches to automating model building do not produce computationally feasible systems and methods.

Thus, as discussed above, even though many well-known statistical techniques are available for analyzing small data sets with low-to-medium dimensionalities, for large data sets of high dimensionality, even the process of selecting predictor variables and normalizing data types within a data set may be infeasible with respect to computational, budgetary, and temporal constraints generally encountered in real-world environments.

### Method and System Embodiments of the Present Invention

The method and system embodiments of the present invention employ numerous well-known statistical techniques along with novel techniques and particular methods for data-type normalization and replacing missing and extreme data values with default and non-extreme values, respectively. The method and system embodiments of the present invention represent a balance between rigorous statistical analysis and practical computational and temporal constraints generally encountered in real-world situations. Furthermore, method and system embodiments of the present invention rely on the high dimensionality of the problem domain to offset use of certain simplistic and less rigorous statistical techniques and methods that allow method and system embodiments of the present invention to efficiently handle large data sets of high dimensionality.

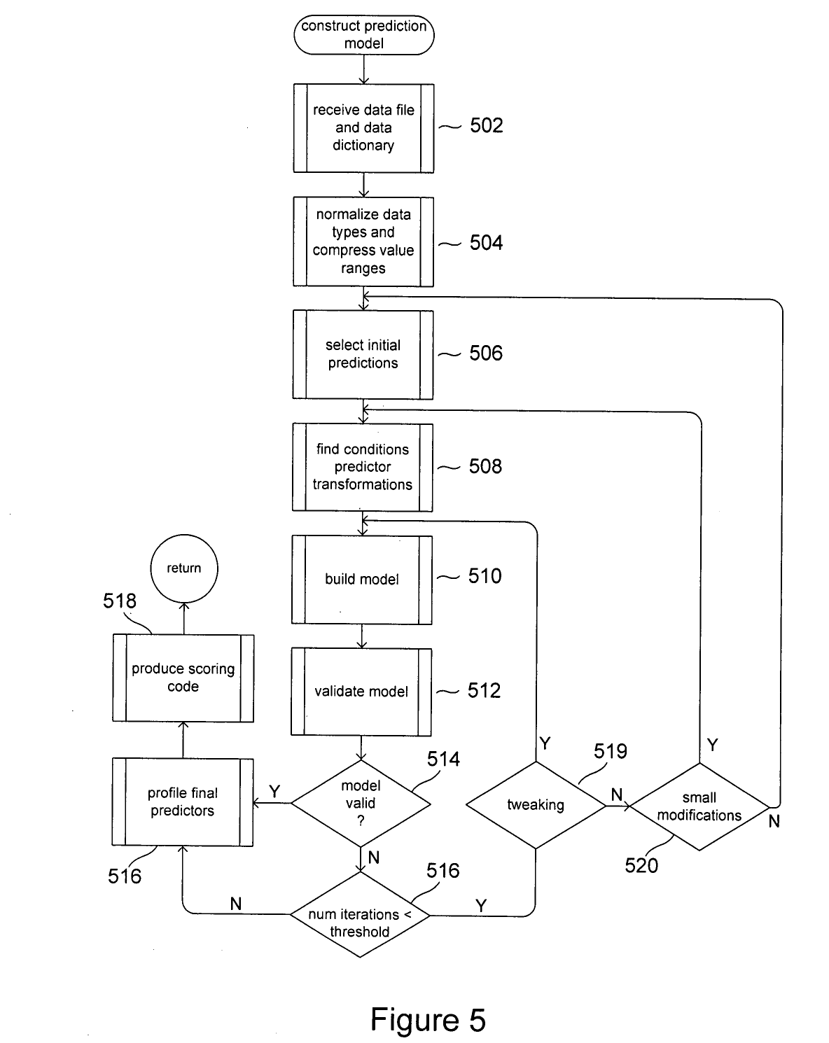

FIG. 5 is a control-flow diagram illustrating one embodiment of the present invention. Numerous routine or procedure calls are shown in FIG. 5, each of which will be discussed, in detail, below. In a first step 502, a data file and data dictionary are received. The data file and data dictionary together comprise the sample data set from which a predictive model is generated. Next, in step 504, the data types within the data set are normalized, default data values are substituted for missing data values, and extreme data values are eliminated. Then, in step 506, a set of initial predictive variables is selected. In step 508, various transformations of the predictive variables are generated, including various spline-related transformations for continuous predictive variables. In step 510, the predictive model is constructed. In step 512, the predictive model is validated. If the model is deemed valid, as determined in step 514, then final predictors are profiled, in step 516, and scoring code, or scripts, are produced, as needed, for predictor variables in step 518 to produce a final, predictive model that can automatically be applied to subsequent data sets. When the model is not valid, and when a number of iterations of model building is less than some threshold maximum number of iterations, as determined in step 516, then, depending on whether tweaking is needed, as determined in step 518, small modifications are needed, as determined in step 520, or large modifications are needed, control returns to step 510, 508, or 506, respectively, in order to retry model building with different parameters. It should be pointed out that the predictive-model-building method illustrated in FIG. 5 can be fully automated within a model-building system, so that a user need only supply the initial data file and data dictionary, received in step 502, to obtain a predictive model, which itself can be automatically applied to subsequent data received on a continuing or intermittent basis. In various analysis and modeling engines, the predictive model may be periodically updated by periodically supplied, additional data sets.

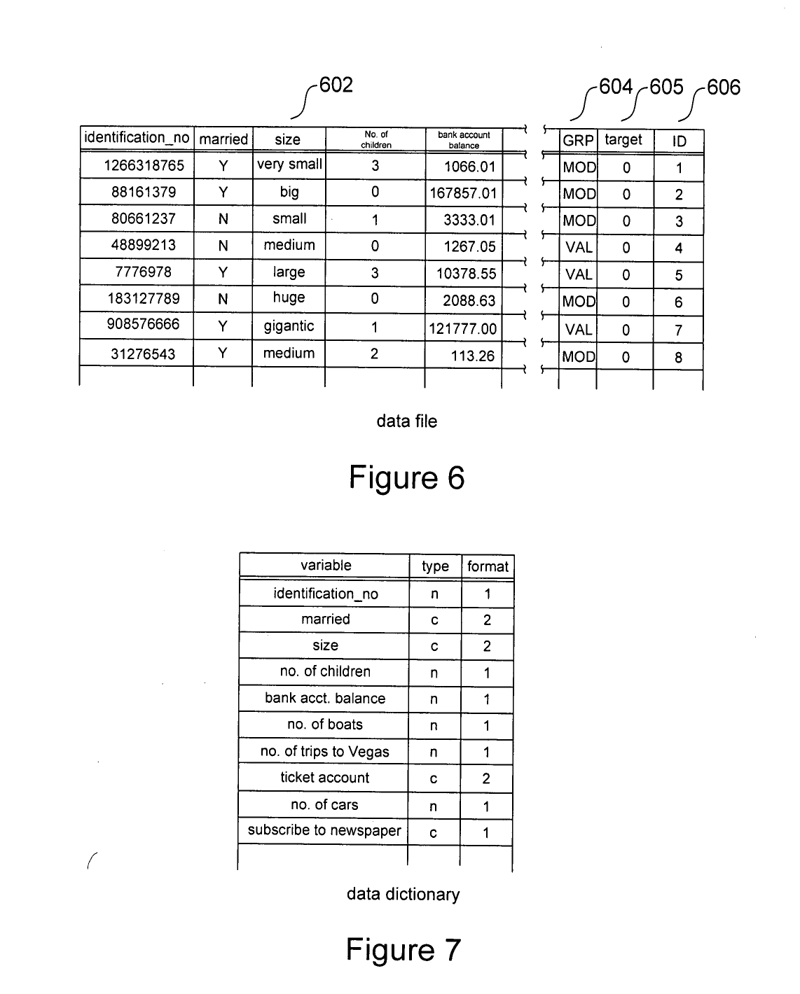

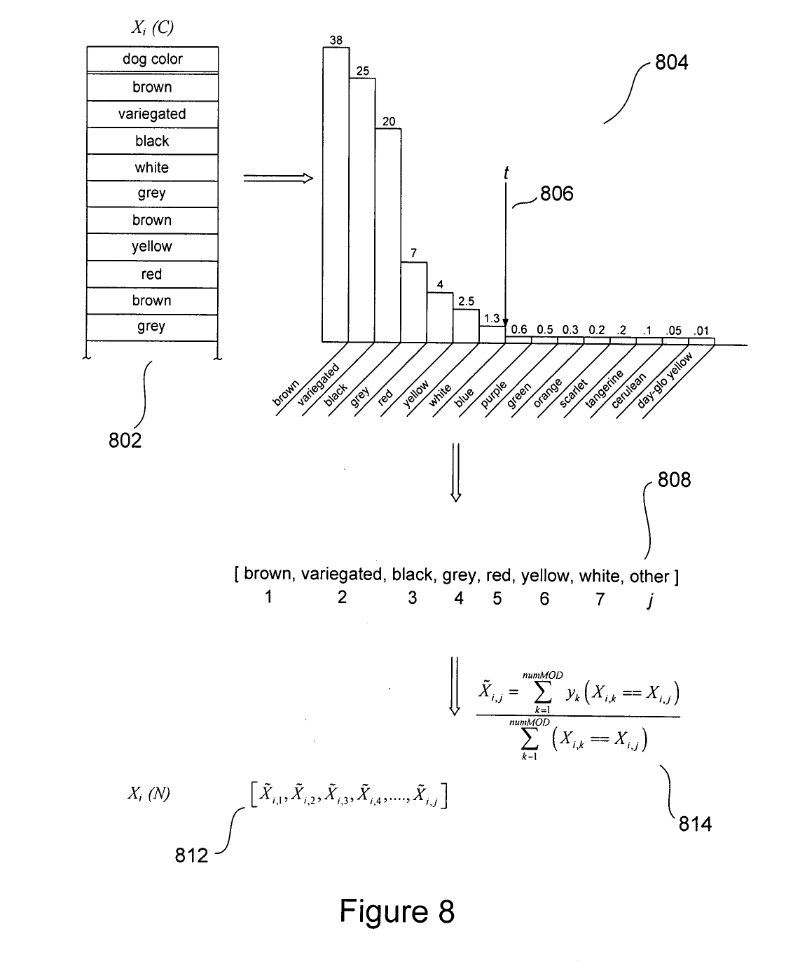

FIGS. 6-7 illustrate small portions of an exemplary data file and accompanying data dictionary, received in step 502 of the method embodiment of the present invention illustrated in FIG. 5. The data file 602 can be considered to be a table comprising record entries, each record entry containing values associated with a large number of fields, or columns, each in turn representing an independent or dependent variable. Certain additional columns 604-606 are added to the data set, to facilitate model building. The column GRP partitions the rows of the data set into two partitions MOD and VAL. The MOD partition includes rows generally used for predictive model building, and the VAL partition includes rows used for validating the predictive model constructed based on the MOD-partition rows. The Target column 605 is used to identify the dependent variable, and the ID column 606 is used to keep track of individual rows during various operations. The data dictionary 702 includes indications of the data type and format of values associated with each column, or field. In one embodiment of the present invention, two data types are employed: (1) n, a numerical data type; and (2) c, a categorical data type. In one embodiment of the present invention, the format symbol “1” indicates a numerically encoded value, and the format symbol “2” indicates a character-string value. In alternative embodiments of the present invention, additional data types and formats may be specified in the data dictionary and handled by the predictive-model-constructing methods and systems that represent embodiments of the present invention. In additional, alternative embodiments, the data file and data dictionary may be formatted in any of many different formats, using any of many different formatting conventions.

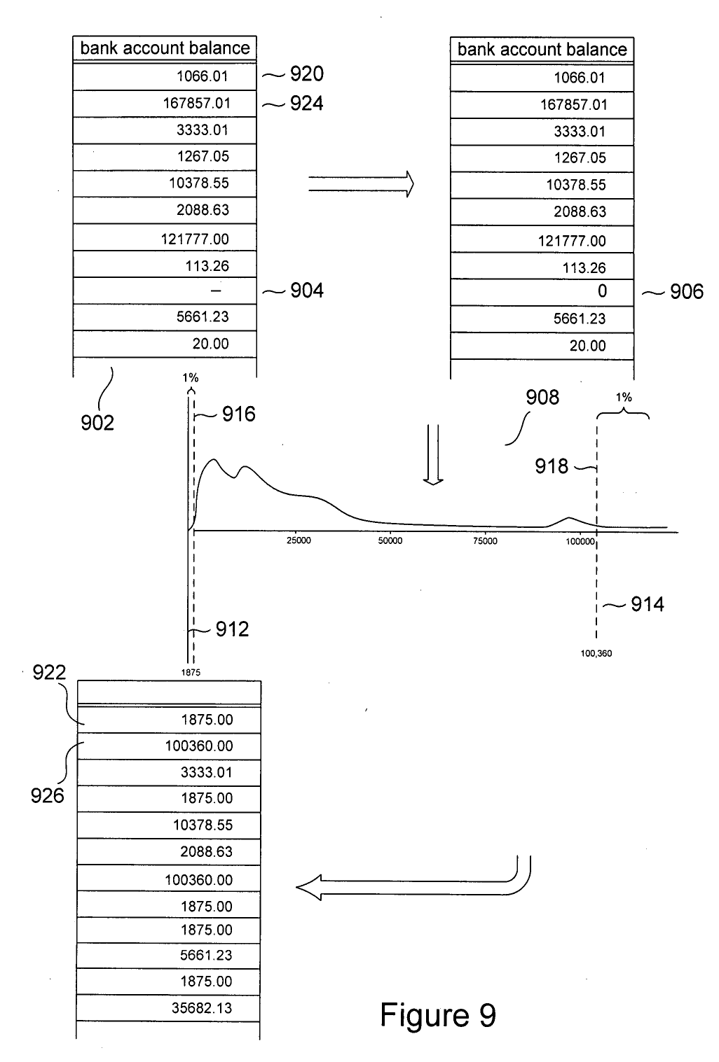

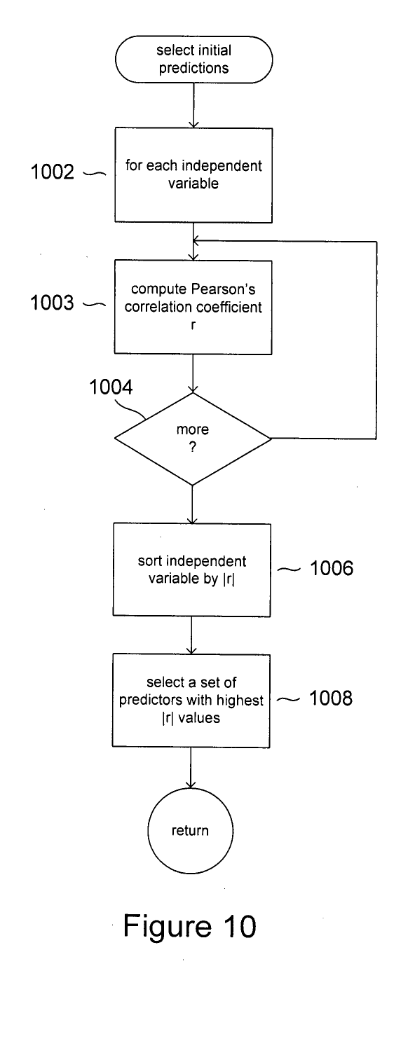

FIGS. 8 and 9 illustrate two methods used in step 504 of FIG. 5. FIG. 8 illustrates transformation of a categorical variable into a corresponding numerical variable according to one embodiment of the present invention. A portion of the values in an exemplary column “dog color” 802 is shown in the upper left-hand portion of FIG. 8. The frequency of occurrence of each of the different values is first computed. The result is shown as a histogram 804 in FIG. 8. All of the values with frequencies of occurrence above a threshold value 806 are retained, and the rest of the values are collapsed into a catch-all value called “other” 808. Then, the set of remaining categorical values 810 is transformed into a set of numerical values 812 by replacing each categorical value with the average value of the dependent variable for entries in which the categorical variable has the given value, as expressed by equation 814 in FIG. 8. The parenthesized expressions are logical expressions that have the value 1, when the two variables within the expression have equal values, and 0, when the two variables inside the parentheses have non-equal values. The operator “==” is taken from the C and C++ programming languages. Any missing categorical-variable values are set to an appropriate value for the categorical variable.

FIG. 9 illustrates replacement of missing data values and removal of extreme data values for continuous independent variables, carried out in step 504 of FIG. 5, according to one embodiment of the present invention. A portion of an exemplary column of the data set 902 is shown in the upper, left-hand portion of FIG. 9. In a first step, all missing data values, such as missing data value 904, are replaced with the value “0” 906. Then, the distribution of values is computed, a graphical distribution result 908 shown in FIG. 9 to represent the distribution, and extreme data values in the lowest 912 and highest 914 1% portions of the distribution are changed to have the lowest and highest remaining values, respectively, or, in other words, minimum threshold 916 and maximum threshold 918 values of the continuous variable. In alternative embodiments of the present invention, different threshold values may be used. As shown in FIG. 9, this results in any data value, such as data value 920 in the original column, with values less than the minimum threshold value 1875 being replaced by the minimum threshold value 1875 (922 in FIG. 9). Similarly, extreme large values, such as extreme large value 924 in the original column, are replaced by the maximum threshold value 926. Substitution for missing data values, and trimming of excessive data values, are both important for the variable-selection and regression techniques used in subsequent steps.

The variable-type normalization, imputing of missing values, and substituting threshold values for extreme values are carried out both on the MOD and VAL partitions of the data set. In addition, scripts for automatically generating each variable-value transformation is generated and stored, for each variable, so that raw, subsequently-provided data sets can be accordingly and automatically transformed in order to prepare the subsequently-provided data sets for application of the predictive model created by embodiments of the present invention.

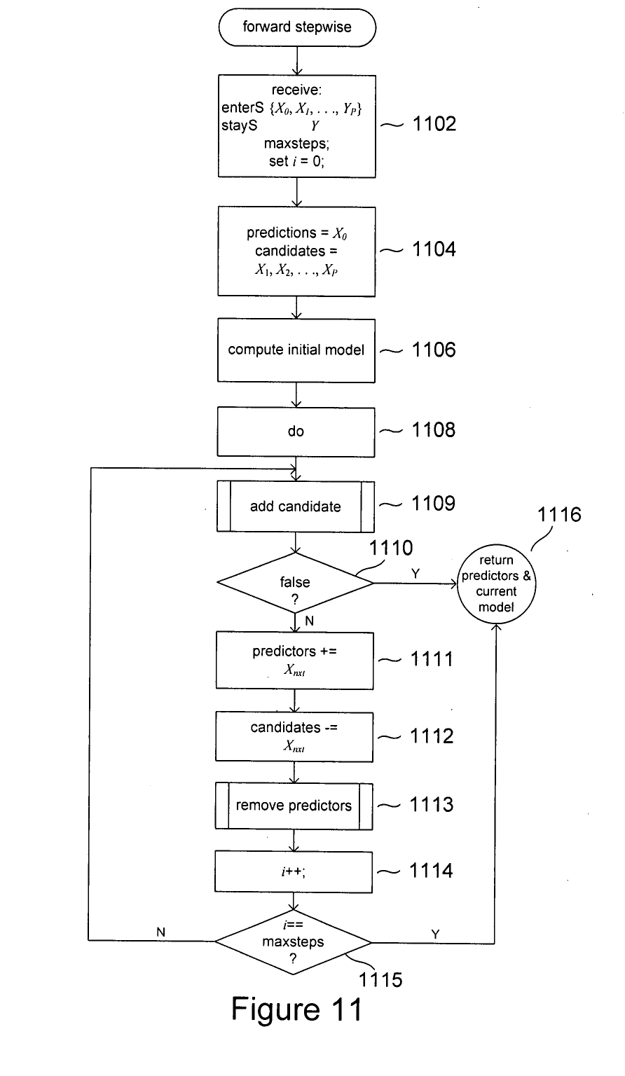

FIG. 10 is a control-flow diagram illustrating one embodiment of step 506 in FIG. 5 according to one embodiment of the present invention. In the for-loop of steps 1002-1004, the routine “selectInitialPredictors” shown in FIG. 10 computes a Pearson correlation coefficient for each independent variable in the data set, based on the MOD partition of the data set. Then, in step 1006, the independent variables are sorted by the absolute value of the Pearson correlation coefficient associated with the independent variables, in descending order. Finally, in step 1008, an initial set of predictors is selected with largest |r| values. A fixed number of initial predictors may be selected, or a set of predictors with |r| values above a pre-selected threshold value may be selected. Alternatively, a fixed percentage of the independent variables with highest |r| values may be selected. In yet alternative embodiments, a more complex analysis of the distribution of the computed Pearson correlations may be employed to select an initial set of predictors. In certain embodiments, between 50 and 75 initial predictors have been found to be most effective.

Next, three different regression-based selection methods are discussed: (1) forward-stepwise regression; (2) forward regression; and (3) backwards elimination. These regression-based selection techniques are used in various of the remaining steps of FIG. 5, discussed below.

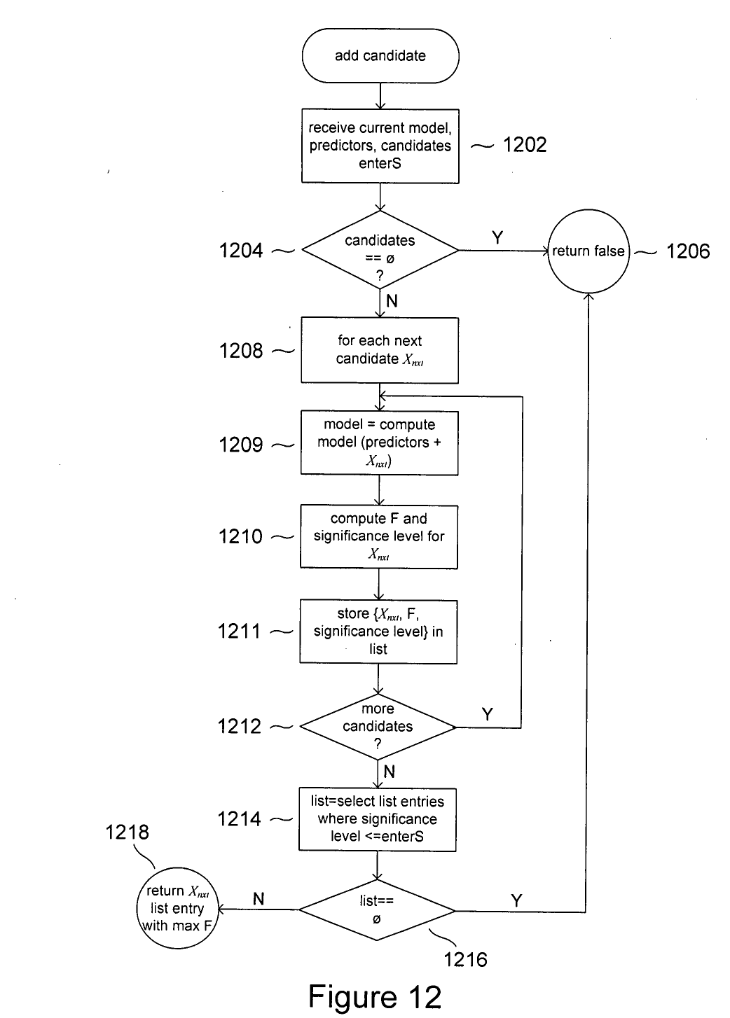

FIG. 11 shows a control-flow diagram for forward stepwise regression according to one embodiment of the present invention. In step 1102, a number of inputs are received: (1) a set of potential predictor variables; (2) a dependent variable; (3) a sample data set following data type normalization, replacement of missing values, and elimination of extreme values; (4) a parameter “enterS,” which supplies a significance level for inclusion of an independent variable into a list of predictor variables; (5) a parameter “stayS,” which indicates a threshold significance level for a predictor to remain in the set of predictors; and (6) a parameter “max steps,” which indicates the maximum number of iterations to be used to generate a predictor list. Also, in step 1102, an iteration variable i is set to zero. In step 1104, a set of predictors is initialized to the set {X₀}. The set of candidate predictors, or selected independent variables, is initialized to the set of independent variables {X₁, X₂, . . ., X_{P}}. The routine “forwardStepwise,” illustrated in FIG. 11, iteratively moves independent variables from the candidates set to the predictors set, and removes independent variables from the predictors set to the candidates set in order to arrive at a final set of predictors. In step 1106, an initial model based on the current set of predictors can be computed by either linear regression or logit regression, depending on the type of dependent variable. Next, in a do-loop of steps 1108-1116, independent variables are moved back and forth between the set of predictors and set of candidates in order to arrive at a final set of predictors. In step 1109, the routine “addCandidate,” discussed below, is called to select a next candidate independent variable for inclusion into the predictors set. If the routine “addCandidate” returns FALSE, as determined in step 1110, then the routine “forwardStepwise” returns, in step 1116. Otherwise, in step 1111, the candidate Xₙₓₜ is added to the set of predictors and, in step II 12, removed from the set of candidates. Then, in step 1113, the routine “removePredictors,” described below, is called to move independent variables from the set of predictors back to the set of candidates, when appropriate. Finally, in step 1114, iteration variable i is incremented and is then compared to the parameter maxsteps, in step 1115. If i is equal to maxsteps, then the routine “forwardStepwise” returns, in step 1116. Otherwise, control flows back to step 1109 for a next iteration of the do-loop.

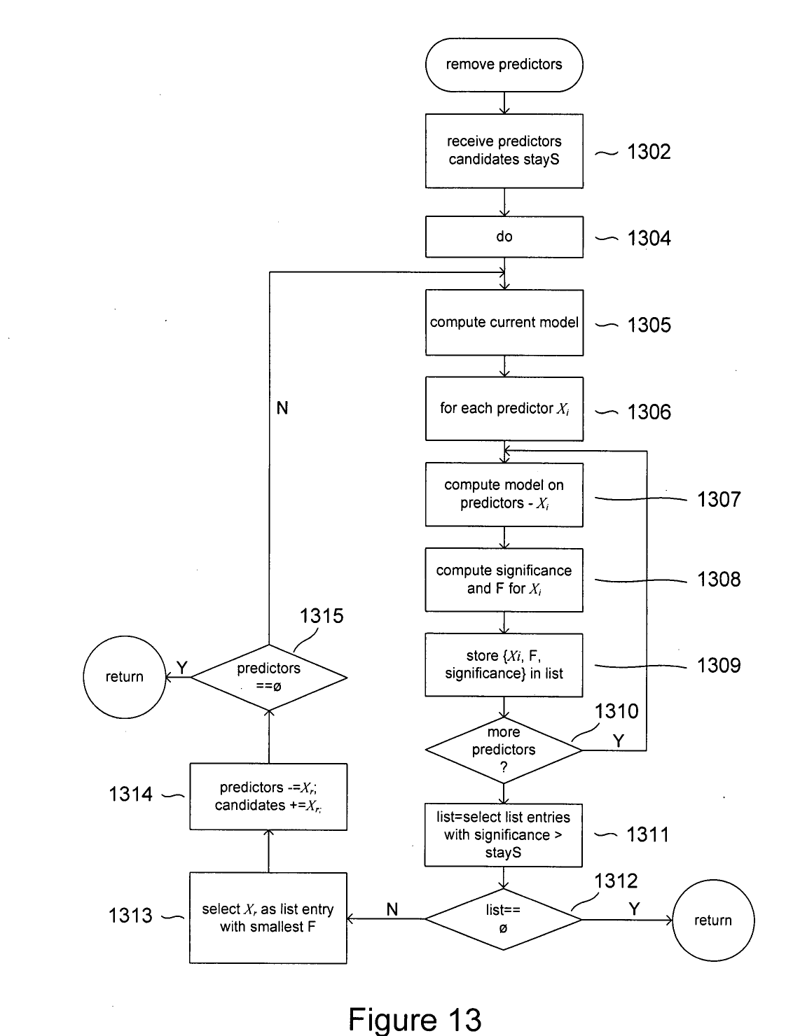

FIG. 12 shows a control-flow diagram for the routine “addCandidate,” called in step 1109 of FIG. 11, according to one embodiment of the present invention. In step 1202, the current model, predictor and candidate sets, and various parameters are received. If the candidates set is the null set, as determined in step 1204, then the routine “addCandidate” returns FALSE, in step 1206. Otherwise, in the for-loop of steps 1208-1212, F statistics and t-test-based significance levels for linear regression models or Wald statistics for logit regression are computed for each candidate independent variable in the candidates set. In step 1209, a new model is computed by linear regression or logit regression, depending on the type of the dependent variable, for the predictors supplemented by the next candidate predictor. An F statistic, for linear regression, or a WALD statistic for logit regression, and a significance level can then be computed for the currently considered candidate variable, in step 1210, and can be stored, along with an indication of the currently considered candidate variable, in step 1211. When F-statistic or Wald-statistic values and significance levels have been computed for all of the independent variables in the set candidates, then the list created by store operations in step 11 is pruned to include only entries with significance levels less than or equal to the parameter “enterS.” In alternative embodiments, step 1214 may be omitted, with step 1211 storing only entries with a significance level less than or equal to the value of parameter “enterS.” If the list is null, as determined in step 1216, then the routine “addCandidate” returns FALSE, in step 1206. Otherwise, in step 1218, the routine “addCandidate” returns TRUE along with the candidate predictor with greatest F-statistic or Wald statistic value.

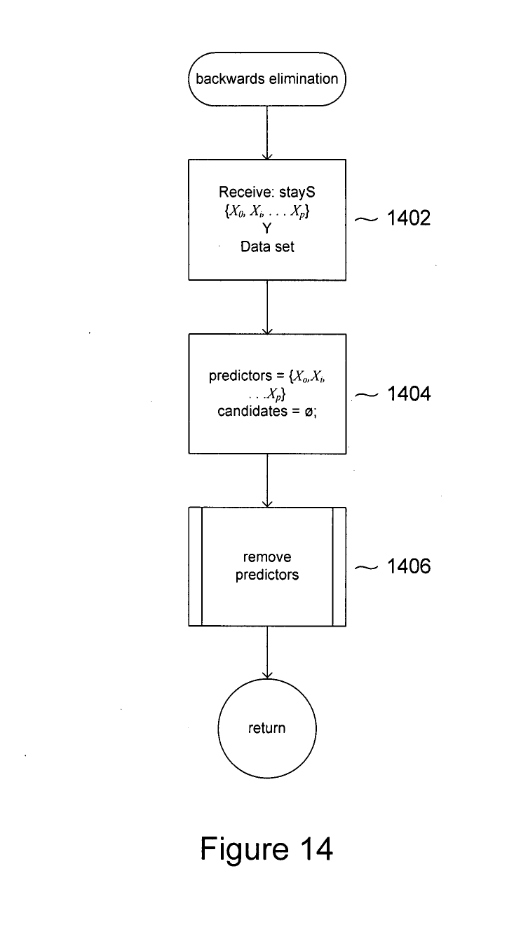

FIG. 13 is a control-flow diagram for the routine “removePredictors,” called in step 1113 of FIG. 11, according to one embodiment of the present invention. In step 1302, the set of predictors and candidates, along with other parameters, is received. Next, in the do-loop of steps 1304-1315, the current predictor with smallest F-statistic or Wald-statistic value is removed from the set of predictors, in each iteration, in order to prune back the set of predictors to a set of predictors with threshold F-statistic or Wald-statistic values and significance levels. In step 1305, the current model is computed based on the current set of predictors. In the inner for-loop of steps 1306-1310, F-statistic or Wald-statistic values and significance levels are computed for each of the current predictors. This is accomplished by computing a model based on the current set of predictors excluding a currently considered predictor, in step 1307, in computing the F-statistic or Wald-statistic value and significance level based on the model in step 1308. The F-statistic or Wald-statistic value and significance level for each predictor is stored in a list, in step 1309. In step 1311, all entries in the list with significance levels less than or equal to the value of parameter “stay S” are removed. In alternative embodiments, step 1311 may be removed, and the step 1309 may be correspondingly altered to store only entries with a significance level greater than the value of “stayS.” If the list is null, as determined in step 1312, then the routine “removePredictors” returns. Otherwise, in step 1313, the next predictor to remove, Xᵣ, is selected from the list as the entry with the smallest F-statistic or Wald-statistic value. In step 1314, Xᵣ is removed from the set of predictors and added to the set of candidates. If the set of predictors is null, as determined in step 1315, then the routine “removePredictors” returns.

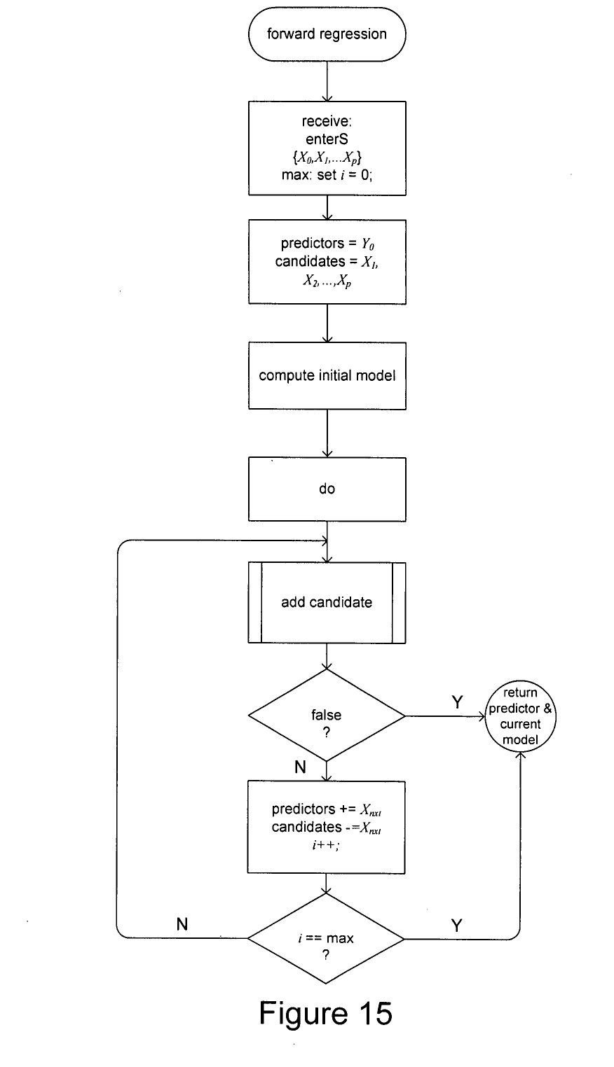

FIG. 14 illustrates the routine “backwardsElimination” according to one embodiment of the present invention. First, in step 1402, the routine “backwardsElimination” receives the parameter “stayS,” described above, the independent and dependent variables, and a data set. In step 1404, the routine “backwardsElimination” initializes the set of predictors to {X₀, X₁, . . . , X_{P}} and initializes the set of candidates to the null set. Then, in step 1406, the routine “backwardsElimination” calls the previously described routine “removePredictors” to iteratively remove predictors from the set of predictors with significance levels greater than a threshold value and F-statistic or Wald-statistic values lower than a threshold value. Thus, backwards elimination involves initially using all independent variables, and iteratively removing independent variables that are not significant predictors for the dependent variable.

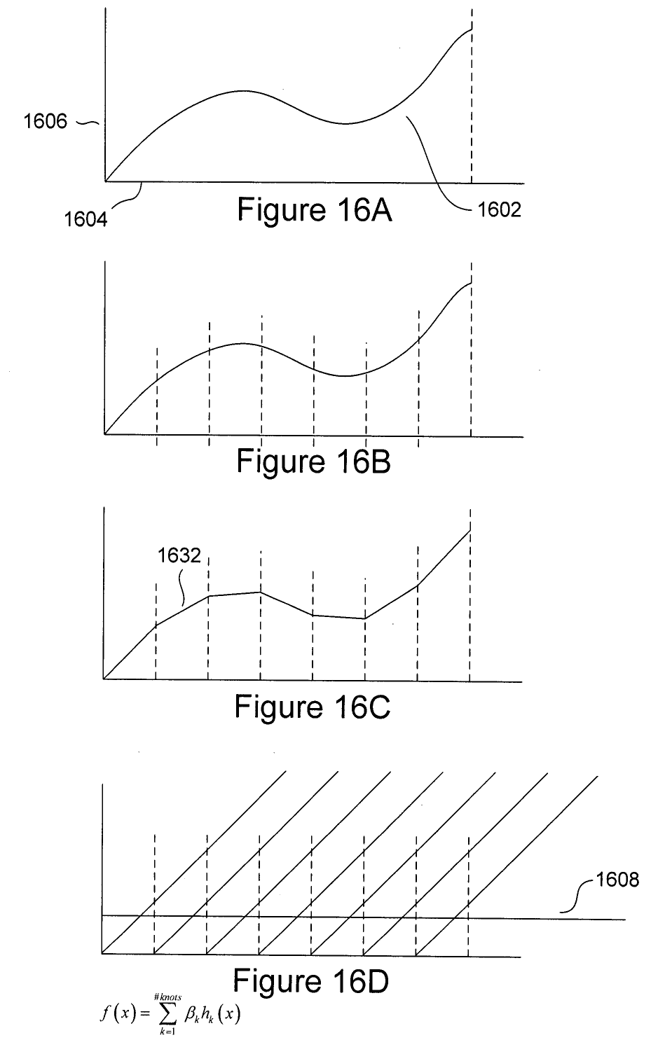

FIG. 15 is a control-flow diagram for the routine “forwardRegression” according to one embodiment of the present invention. Forward regression is similar to forward stepwise regression, except that no predictor elimination is undertaken. Thus, forward regression begins with a set of predictors {X₀} and a set of candidates {X₁, X₂, . . . , X_{P}} and iteratively adds candidates to the set of predictors, via a call to the routine “addCandidate,” discussed above, until either there are no suitable additional candidates to add, or a maximum number of candidates have been added to the set of predictors.

In the above-described routines, different statistics may be used in place of the F statistic, Wald statistic, and t-test statistic in alternative embodiments of the present invention. In addition, various shortcuts may be employed to add and remove multiple predictors in each iteration of the loops, rather than one-at-a-time.

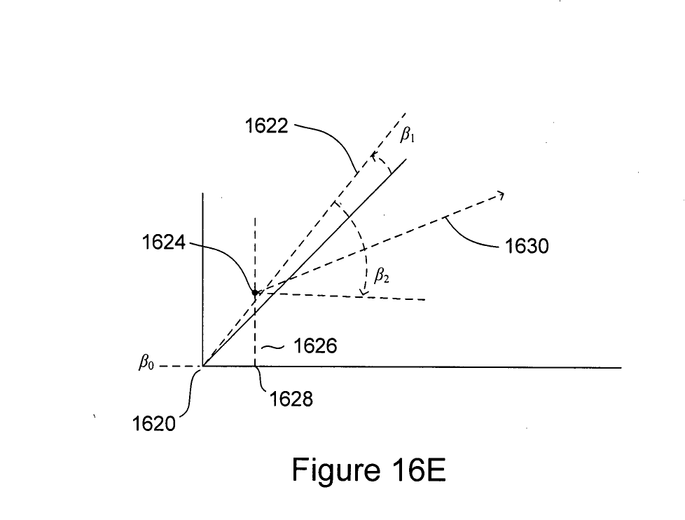

Various types of techniques may be used to linearize a non-linear function. Method and system embodiments of the present invention may use any number of such linear transformations. One frequently used transformation is referred to as the “linear spline” transformation. FIGS. 16A-E illustrate linear spline transformation of a non-linear function. FIG. 16A shows the non-linear function. The non-linear function is plotted as a curve 1602 with respect to a horizontal axis 1604 and vertical axis 1606. In a first step, the range of values of the independent variable is divided into intervals, as shown in FIG. 16B. The boundaries of these intervals are referred to as knot points. For each interval, the portion of the non-linear function within the interval is approximated by a straight-line segment, as shown in FIG. 16C. In one popular linear-spline technique, the sequence of linear segments, shown in FIG. 16C, is generated from a set of basis functions shown in FIG. 16D. The basis functions include a constant function 1608 and a set of functions with positive portions beginning at each knot point and rising with slope 1. The function that is being approximated, ƒ(x), is thus approximated as:

$$f ( x ) = {\sum }_{k = 1}^{\# knots} {β}_{k} {h}_{k} ( x )$$

FIG. 16E illustrates how the sum of basis functions hₖ(x) are added together, following multiplication by parameter βₖ, to produce an approximation of the non-linear function. The initial parameter β₀ selects the intercept of the first segment with the vertical axis 1620. The term β₁h₁(x) finds the first line segment 1622 in terms of a linear function with slope adjusted from “1” by the parameter β₁, in order that the first line segment intercepts the proper point 1624 from the vertical line 1626 passing through the first knot point 1628. Then, adding the term β₂h₂(x) to the term β₁h₁ (x) results in a new line 1630 with a slope equal to the desired slope for the segment of the approximation in the second interval (1632 in FIG. 16C). Successive addition of terms continues to change the slope of successive line segments to the desired slopes of line segments shown in FIG. 16C. Thus, a linear spline transformation of non-linear function results in an additional number of linear terms comprising a linear function hₖ of the independent variable multiplied by a parameter βₖ. In embodiments of the present invention, these additional terms are added as additional independent variables to a model.

In addition to linear-spline transformations, there are also step-function-spline transformations, radial-basis-function transformations, natural-cubic-spline transformations, b-spline transformations, and many additional types of linear transformations. Pseudocode for generation of a series of linear-spline, step-function-spline, radial-basis, and natural-cubic-spline transformations is provided below:

linear_splineᵢ = {(x > knotᵢ)*(x − knotᵢ,)}
step_function_splineᵢ = {(x > knotᵢ)}
c radial basis functions

| b = bandwidth; | |
|---|---|
| c = 0; | |
| for (a = 1; a < mark; a⁺⁺) | |
| { | for (i=0; i ≦ a; i⁺⁺) |
| | { |

C++;
r center = min(x) + ((max(x) − min(x))/a) * i);
r bandwidth = ((max(x) − min(x))/a) * b;
$r {spline}_{c} = \{ {e}^{- ( x - rcenter ) 2 / rbandwidth} \} ;$

}

}

natural cubic splines

N₁(x) = {1};
N₂(x) = {X};
for (i = 3; i < = k; i++)
{

Ni(x) = {dᵢ₋₂(x)−dₖ₋₁(x)};

| | } |
|---|---|
| where | ${d}_{n} ( x ) = \frac{{( x - {knot}_{n} )}^{3} ( x > {knot}_{n} ) - {( x - {knot}_{max} )}^{3} ( x > {knot}_{max} )}{{knot}_{max} - {knot}_{n}}$ |

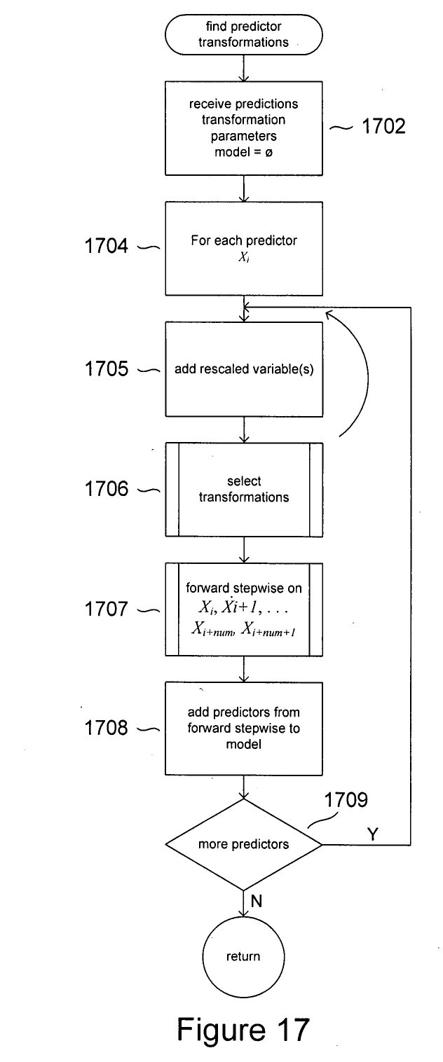

FIG. 17 is a control-flow diagram for the routine “findPredictorTransformations,” called in step 508 of FIG. 5, according to one embodiment of the present invention. In step 1702, a set of predictors and transformation parameters are received, and the current model is initialized to the null set. Next, in a for-loop of steps 1704-1709, transformations are generated for each of the predictors and are then added, by forward stepwise regression, to the model. The transformation parameters include parameters indicating which of the possible linear transformations should be applied to each predictor, the number of knot points to use, and other such parameters defining generation of linear transformations. Then, in step 1705, one or more rescaled variable transformations may be added for predictor Xᵢ. In step 1706, additional independent variables corresponding to linear-transformation basis functions βₖhₖ(x) are generated for the currently considered predictor Xi according to the parameters received in step 1702, resulting in additional independent variables {Xᵢ₊₁, Xᵢ₊₂, . . . Xᵢ₊ₙᵤₘ}. Then, in step 1706, rescaled variable transformations are added for selected independent variables of the set {Xᵢ, Xᵢ₊₁, . . . Xᵢ₊ₙᵤₘ}. In step 1707, forward stepwise regression is carried out on the currently considered predictor and all additional independent variables corresponding to linear transformation terms for the predictor, with respect to the MOD portion of the data set, and the set of predictors obtained from forward stepwise regression is added to a final, initial model.

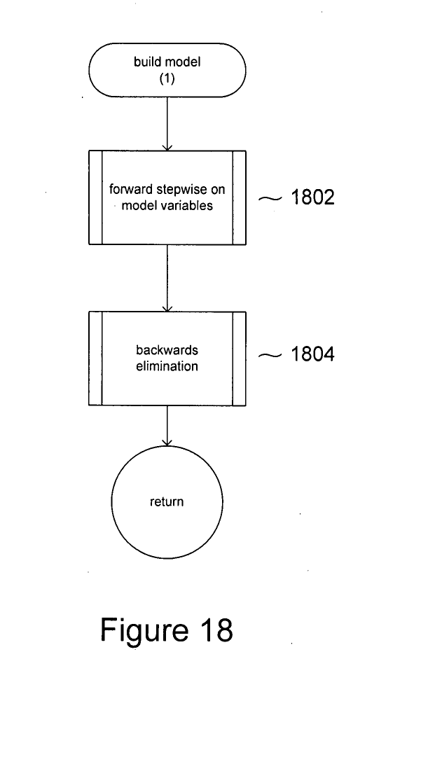

FIG. 18 is a control-flow diagram for a first embodiment of the routine “buildModel” called in step 510 of FIG. 5, according to one embodiment of the present invention. FIG. 18 shows a first embodiment of the routine “buildModel.” In this embodiment, the final, initial set of predictors produced in step 508 of FIG. 5 are used as candidate predictor variables in a forward stepwise regression, in step 1802, with respect to the MOD partition of the data set. Stringent enterS and stayS, and maxsteps parameter values, such as 0.05, 0.05, and 75, respectively, are generally used in the model building phase. Then, in step 1804, backwards elimination, also with respect to the MOD partition, is applied to the set of predictors generated in step 1802. The set of predictors generated from application of backwards elimination, in step 1804, represents a final predictive model. In other words, in the first embodiment of the routine “buildModel,” more stringent acceptance and entry thresholds are employed to eliminate all but the most desirable of the initially identified predictors. In certain embodiments, the stays parameter may be set to a very low, stringent value, such as 0.0001.

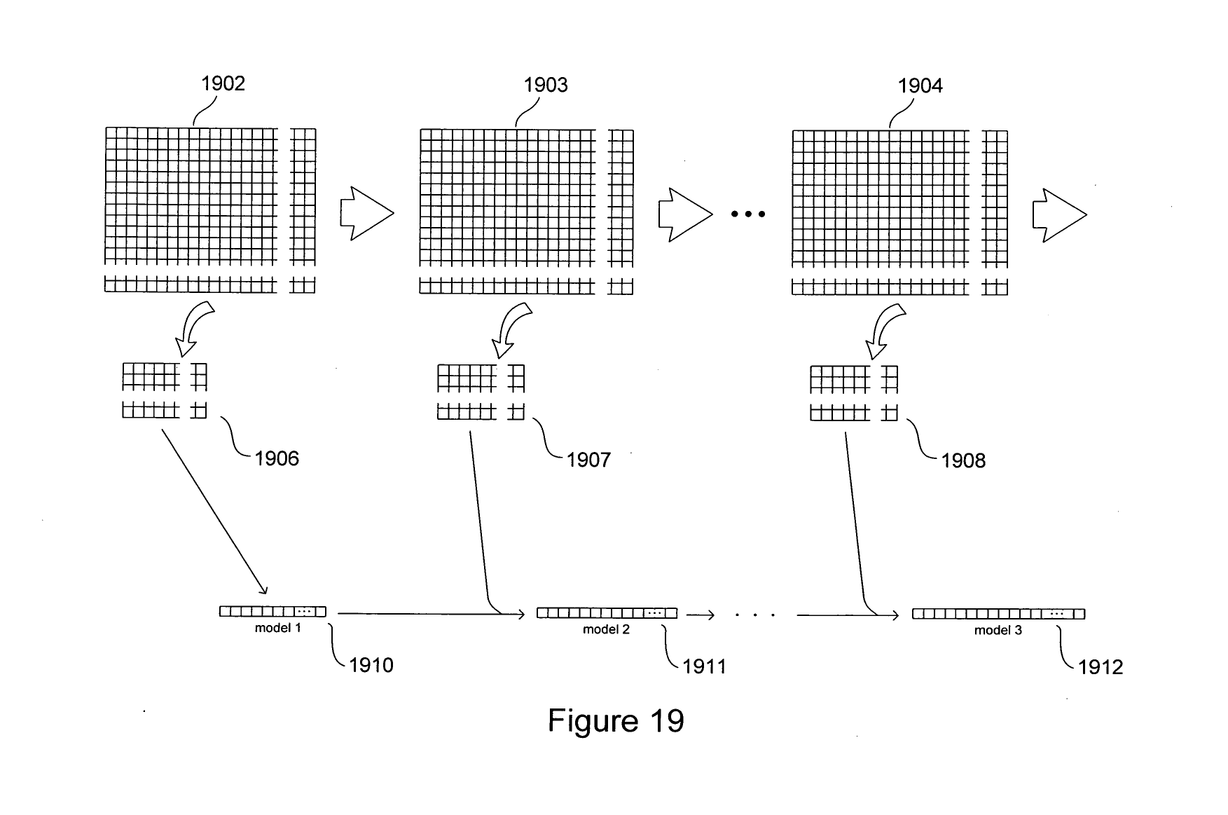

A second “buildModel” routine is next described. FIG. 19 illustrates an alternative “buildModel” routine according to one embodiment of the present invention. The second “buildModel” routine is an iterative, stochastic method. At each step in the process, as illustrated by the sequence of data sets 1902-1904 in FIG. 19, a number of independent variables and a number of records are randomly selected from the data file to produce small data-file subsets 1906-1908. The first data-file subset 1906 is used to construct an initial model 1910. In each successive iteration, a next data-file subset, such as data-file subset 1907, is used to add additional parameters to the data model to enhance the data model, such as enhanced data model 1911. The process continues until convergence or a maximum number of iterations have been carried out, producing a final model 1912.

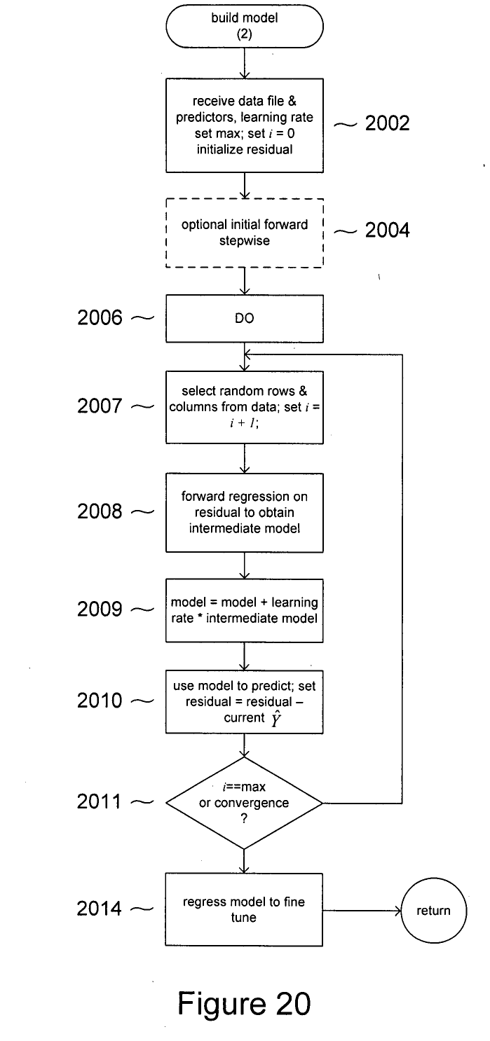

FIG. 20 is a control-flow diagram that illustrates the second “buildModel” routine called in step 510 of FIG. 5 in an alternate embodiment of the present invention. In step 2002, the routine “buildModel” receives a data file, following the data-type normalization, value-range compression, and substitution of default values for missing data in step 504 of FIG. 5, and additional parameters. Also, in step 2002, an iteration variable i is set to 0, and a residual dependent-variable value is initialized to the initial dependent-variable values of the data file. In an optional second step 2004, an initial forward stepwise regression may be carried out on the initial predictor list with additional transformations, produced in step 508, with respect to the MOD partition. Stringent enterS and stayS, and maxsteps parameter values, such as 0.05, 0.05, and 75, respectively, are generally used in this step. Next, in a do-loop of steps 2006-2011, successive stochastic iterations, as described above with reference to FIG. 19, are carried out. In step 2007, a new data-file subset is randomly selected. In step 2007, the iteration variable i is also incremented. In step 2008, a forward regression is carried out on the data-file subset against the current residual value in order to obtain an intermediate model. Somewhat relaxed parameters are generally employed. In step 2009, the current model is supplemented, or augmented, with additional parameters obtained in the forward regression of step 2008. The parameters are adjusted by the learning rate, a number greater than 0 and less than or equal to 1, for the new variables added to the model. Then, in step 2010, the current model, with additional parameters added in step 2009, is employed to generate, from the entire MOD partition of the data set, a current set of predicted dependent-variable values, Ŷ. that are subtracted from the current residual to produce a next residual used in a next iteration of the do-loop. If the number of iterations carried out is equal to a maximum number of iterations specified as a parameter, or convergence has been reached, then the current model is fine-tuned by yet an additional regression, in step 2014. Otherwise, another iteration of the stochastic method is carried out in the do-loop of steps 2006-2011. Convergence can be determined in a number of different of different ways, including computation of an R² computation and determining whether R² is less than some threshold value, or by determining that the most recently added intermediate model is a linear combination of the previous model generated by the previous iteration of the do-loop of steps 2006-2011, and then backing out the most recently added intermediate model.

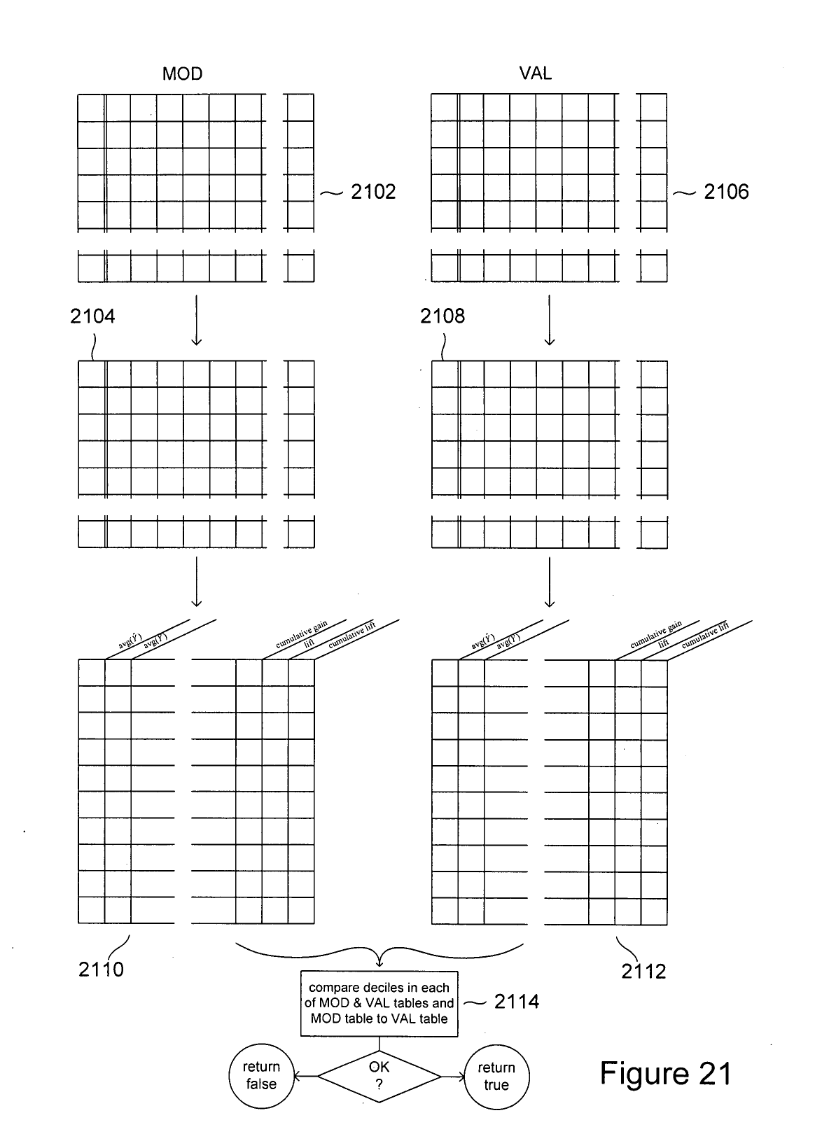

As discussed above, a data file is generally divided into a MOD portion and a VAL portion, with the VAL portion, identified by a VAL flag or indication in a specially added column GRP, held as holdback entries for use in validating the predictive model constructed using the MOD portion of the data set. Following production of the final model by either the two different versions of the “buildModel” routine, the model is validated. FIG. 21 illustrates model validation in one embodiment of the present invention. As shown in FIG. 21, the model is applied to the MOD portion of the data file 2102 to produce predicted dependent-variable values Ŷ 2104 for the MOD portion of the data file, and the VAL portion of the data file 2106 to produce predicted values Ŷ 2108 for the VAL portion of the data file. Then, the MOD portion of the data file and the VAL portion of the data file are sorted in descending order on the predicted dependent-variable values Ŷ, and divided into deciles based on the Ŷ values, and these data files divided by deciles are used to compute a number of standard parameters for each decile, including the cumulative gain, lift, cumulative lift, average predicted value, and average actual dependent-variable value. Thus, a decile-divided data set with computed parameters is produced for the MOD portion of the data file 2110 and for the VAL portion of the data file 2112. A cumulative gain for a given decile is the ratio of the sum of predicted dependent-variable values

$${\sum }_{i = 1}^{n} {\hat{Y}}_{i}$$

for the samples in all deciles down to an including the given decile, n, divided by an the sum of predicted dependent-values for all samples

$${\sum }_{i = 1}^{n} {\hat{Y}}_{i}$$

The cumulative gain is computed for a currently considered decile combined with all prior, previously considered deciles as the deciles are traversed, in highest-to-lowest order. The lift is computed for each decile as the ratio of the average values Y for the samples in the decile divided by the average value of the dependent variable for all of the samples. Next, in step 2114, the computed values avg(Ŷ), avg(Y), cumulative gain, lift, and cumulative lift are compared among deciles in each of the two decile-divided data files 2110 and 2112 and compared between the two decile-divided data files 2110 and 2112 in order to determine whether the model appears to be valid. In a valid model, there should be strong differentiation between the lift in the top deciles versus the bottom deciles, the average predicted values should relatively closely match the average dependent-variable values in each decile, and the lift and cumulative gain metrics in the MOD decile-divided data set 2110 should relatively closely match those in the VAL decile-divided data file 2112. Additional parameters can be set to determine whether these comparisons are sufficiently close in order to determine whether or not the model is valid.

Once a model has been validated, then, in step 516 of FIG. 5, profiles are generated for the continuous independent-variable predictors averaging the value of the predictors for the records associated with largest predicted dependent-variable values in comparing the computed average for the average value of the continuous independent-variable predictor over the entire VAL portion of the data file. Categorical-variable predictors are also profiled. An average dependent-variable value for each class is computed along with the relative frequency of occurrence of the class. An index value is computed for each class, comprising the average dependent-variable value for the class minus the overall sample average divided by the overall sample average. Many additional profile metrics may also be computed for each of the final model predictors. These profiles are automatically generated by the modeling system.

Finally, in step 518 of FIG. 5, script code is generated for calculation of each of the final-model predictors involving transformations, such as linear-spline transformations or, when the second “buildModel” routine is employed, the transformations involving multiplication by the learning rate. The script code can then be used to subsequently produce values corresponding to the additional independent variables generated by original-independent-variable transformations for subsequently provided data sets. In other words, the predictors used in the predictive model may include both original, independent variables as well as additional independent variables derived from the original independent variables. Script code is included in the model to allow values for all of these additional independent variables to be generated. Several example SAS scoring scripts are provided, below:
CURR_RES_MTHS_{—}30=(((CURR_RES_MTHS−1)/(408−1))>0.149253731343)*(((CURR_RES_MTHS−1)/(408−1))−0.149253731343);
B_ENQ_L6M_GR3_{—}43=(((B_ENQ_L6M_GR3−0)/(3−0))>0.2139303482583)*(((B_ENQ_L6M_GR3−0)/(3−0))−0.2139303482583);

Finally, as discussed above, with a predictive model generated by the above discussed techniques, predictions of the values of the dependent variable can be automatically generated for subsequently-provided data. In general, these predictions are stored in a computer readable medium for subsequent use by human analysts or for use by various automated systems that may use the predictions for various tasks, including automated stock transactions, marketing-materials production, experimental-protocol generation, and other such tasks.

Although the present invention has been described in terms of particular embodiments, it is not intended that the invention be limited to these embodiments. Modifications within the spirit of the invention will be apparent to those skilled in the art. For example, any number of different implementations of the automatic predictive-model building method and system of the system embodiments of the present invention can be obtained by using different programming languages, existing statistical packages, different modular organizations, different control structures, different data structures, different variables, and by varying other such programming parameters. At each step in the process illustrated in FIG. 5, different fixed number of iterations, significance-level thresholds, and F-statistic thresholds may be employed in different cases. In alternative embodiments of the present invention, many different additional refinement steps may be employed, and additional types of predictive algorithms may be employed in place of linear-regression and logit regression.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. An automated data-analysis system comprising:
a data-set and data-dictionary receiving routine;
an automated model-building-and-validation program that constructs a predictive model from a received data set and data dictionary; and
an automated means for applying the predictive model to subsequently received data to predict values for a dependent variable and store the predicted values in computer-readable form in a computer-readable medium.

2. The automated data-analysis system of claim 1 wherein the automated model-building-and-validation program further includes:
data-normalization logic that automatically supplies default values for missing data, replaces extreme data values, and transforms categorical data to numeric data;
initial-predictor-selection logic that selects a first, initial set of predictors from the data set;
predictor-transformation logic that adds linear-transformation-related predictors to the first, initial set of predictors to produce a final, initial set of predictors;
model-building logic that selects a final set of predictors from the initial set of predictors, the final set of predictors comprising a predictive model;
model-validation logic that validates the predictive model;
final-predictor profiling logic that generates profiles of the final predictors; and
script-generation logic that supplements the predictive model with scripts that automate data-value transformations needed by the predictive model.

3. The automated data-analysis system of claim 2 wherein the data set includes a number of rows, each row a record representing an entity described by the row, and each row including values for each of a number of columns that represent the fields within each record.

4. The automated data-analysis system of claim 2
wherein the columns comprise variables, including independent variables that constitute potential predictors, and the dependent variable; and
wherein variables include continuous variables and categorical variables.

5. The automated data-analysis system of claim 4 wherein the data-normalization logic comprises one or more routines that:
collapse all categorical values of each categorical variable that occur with less than a threshold frequency in the data set to a single, catch-all categorical value;
assign the catch-all categorical value for a categorical variable to the categorical-variable value of rows missing a value for the categorical variable; and
transform categorical variables into continuous, numeric variables by replacing each categorical-variable value with average values of the dependent variable for all rows with dependent-variable value equal to the categorical-variable value.

6. The automated data-analysis system of claim 5 wherein the data-normalization logic further comprises one or more routines that:
set missing data values for continuous variables to “O;” and
replaces data values for continuous variables less than a minimum-threshold value to the minimum-threshold value and data values for continuous variables greater than a maximum-threshold value to the maximum-threshold value, respectively.

7. The automated data-analysis system of claim 6 wherein the initial-predictor-selection logic that selects a first, initial set of predictors from the data set by computing a correlation coefficient, for each potential predictor in the data set, that represents a degree to which the potential predictor is correlated with the dependent variable, and by then selecting, as the first, initial set of predictors, those potential predictors most strongly correlated with the dependent variable as determined by the value of the corresponding computed correlations for the potential predictors.

8. The automated data-analysis system of claim 7 wherein the correlation coefficient is an absolute value of a Pearson's correlation coefficient, with potential predictors having highest absolute values of computed Pearson's correlation coefficients selected as the first, initial set of predictors.

9. The automated data-analysis system of claim 5 wherein the predictor-transformation logic further comprises one or more routines that:
for each predictor in the first, initial set of predictors,
adds rescaled predictors for the predictor and transformed predictors to the temporary set of predictors;
selects linear transforms for the predictor and include transformed predictors, based on the selected linear transformations, along with the predictor in a temporary set of predictors;
selects additional predictors related to the predictor by forward, stepwise regression with respect to a portion of the data set; and
adds the predictor and additional predictors to the final, initial set of predictors.

10. The automated data-analysis system of claim 5 wherein the model-building logic further comprises one or more routines that:
selects an intermediate set of predictors by forward, stepwise regression with respect to a portion of the data set; and
refines the intermediate set of predictors by backwards elimination to produce a final set of predictors.

11. The automated data-analysis system of claim 5 wherein the model-building logic further comprises one or more routines that:
iteratively,
randomly selects a number of rows from the data set and potential predictors from the final, initial set of predictors to produce a small model;
selects, by forward regression with respect to a residual set of values, a next set of additional predictors;
adds the next set of additional predictors to the final set of predictors; and
regresses the final set of predictors with respect to a portion of the database to generate an updated, residual value for use in a subsequent iteration
until either convergence or execution of maximum number of iterations.

12. The automated data-analysis system of claim 5 wherein the model-validation logic further comprises one or more routines that:
generates a decile-divided set of predicted values for each of a first and second portion of the data set;
computes metrics for each decile of the decile-divided set of predicted values, including cumulative gain, lift, cumulative lift, average predicted dependent-variable value, and average dependent-variable value; and
compares the computed metrics to determine whether the two decile-divided sets are sufficiently closely related, and whether the deciles within the two decile-divided sets are sufficiently well differentiated from one another by computed metric values, to designate the predictive model valid.
